(19) United States
(12) Patent Application Publication
(10) Pub. No.: US 2010/0132802 A1
(43) Pub. Date: Jun. 3, 2010

(54) GAS ADAPTOR

(75) Inventor: Andrew Coventry, Burleigh Heads (AU)

Correspondence Address: THE ECLIPSE GROUP LLP, 10605 BALBOA BLVD., SUITE 300, GRANADA HILLS, CA, 91344, US

(73) Assignee: BANTIX WORLDWIDE PTY LTD, Burleigh Heads (AU)

(21) Appl. No.: 12/650,992

(22) Filed: Dec. 31, 2009

Related U.S. Application Data
(63) Continuation-in-part of application No. PCT/AU2008/000989, filed on Jul. 4, 2008.

(30) Foreign Application Priority Data
Jul. 4, 2007 (AU) AU2007903624

(51) Int. Cl. G05D 16/04; F15D 1/00; F15C 1/06

(52) U.S. Cl. 137/14; 138/41

(57) ABSTRACT

A gas adaptor (10) adapted in use to reduce the pressure of a gas or flow rate of a liquefied gas, said gas adaptor (10) having means (14) for connection to a gas source; an adaptor body (13, 13A) having an internal bore (22) in which is located a ceramic insert (27); and a capillary tube or passage (24) in fluid communication with the internal bore (22) wherein in use the gas or liquefied gas is caused to flow through the internal bore (22) of the adaptor body (13, 13A) and through the ceramic insert (27) and subsequently through the capillary tube or passage (24).

This application claims priority and incorporates by reference co-pending and commonly assigned PCT Application No. PCT/AU2008/000989 filed Jul. 4, 2008 for Gas Adaptor and through the PCT application claims priority to and incorporates by reference Australian Patent Application No. 2007903624 filed Jul. 4, 2007.

This invention relates to a gas adaptor which is used to reduce and regulate the pressure or flow rate of a gas or of a liquefied gas. In one aspect the gas adaptor can interconnect a source of gas such as a gas bottle or gas cylinder to apparatus which utilizes the gas such as a gas heater or gas barbeque. The gas adaptor reduces the pressure of the gas to low pressure which can be utilized in gas utilization apparatus in a safe and effective manner.

Hitherto when it was desired to connect a source of high pressure gas to a gas utilization apparatus it was necessary to use a regulator. Thus for example when it was necessary to connect a SCUBA gas cylinder to breathing apparatus it was necessary to reduce the pressure in the gas cylinder from 240 atmospheres to 1-5 atmospheres. This is achieved by a regulator which in a first stage has a high pressure chamber and an intermediate pressure chamber which are separated from each other by a valve diaphragm combination or a piston which is in contact with ambient water pressure. The high pressure chamber receives air directly from the cylinder while the intermediate pressure chamber is in contact with the ambient water pressure through the diaphragm or piston. The regulator also has a second stage which is connected to the first stage and has a chamber with an outer rubber diaphragm that is in contact with ambient water pressure. The second stage also has a purge button and an inner valve that is connected to a movable lever exhaust valve and mouthpiece. The second stage reduces the first stage pressure of 9.5 atmospheres to 1-5 atmospheres.

Reference also may be made to U.S. Pat. No. 6,796,326 which describes a pressure regulator of complicated construction having a gas-tight casing that houses an inlet side chamber and an outlet side chamber connected to each other by a passage to accommodate a valve seat to retain a valve disc that is guided through a rod and can be moved in an axial direction inside the casing wherein the rod is connected to a pressure diaphragm in contact with an adjusting spring. There is also provided a closing body connected to an armature of an electro-magnetic drive.

Reference may also be made to U.S. Pat. No. 6,769,447 which describes a regulator valve having a valve chamber which regulator valve has a cap member which holds an elongate rotatable control key in operative association with a rotatable flow regulating plug member located in the valve chamber. The plug member includes an inlet orifice which can communicate with a gas flow inlet passage and an outlet orifice. There is also provided a spring for biasing the control key. The regulator valve also includes a press member carried on the control key and retained thereon by a clip.

Reference also may be made to U.S. Pat. Nos. 6,318,407, 5,018,965, 5,566,713, 5,975,121 and 4,217,928 all of which relate to gas regulators of complicated structure and construction.

Reference may be made to WO2006/108244 which refers to catalytic oxidation of hydrocarbon gas wherein pulses of a compressed hydrocarbon from a container of the compressed hydrocarbon gas are passed into an expansion chamber and subsequently passed over a catalytic converter to oxidize the hydrocarbon gas. The hydrocarbon gas is released from the gas bottle through a porous ceramic slug mounted in a gas take off from the gas container. The porous ceramic slug has an interconnected network of interstices through which the passage of hydrocarbon gas is restricted. The hydrocarbon gas is released from the gas container without the need for a regulator by releasing the compressed hydrocarbon gas through a restrictor tube into a valve such as an electronically controlled valve and then into another restrictor tube that is connected to the expansion chamber. It is also disclosed in this reference that small amounts of hydrocarbon gas may be released in a controlled manner from the gas container by passing the hydrocarbon gas through a small diameter orifice located in an electronic valve directly attached to the gas container or via the restrictor tube which is connected to the electronic valve.

It is therefore an object of the invention to provide a gas adaptor which may replace a conventional pressure regulator or regulator valve which is effective in operation and of simple structure.

The gas adaptor of the invention is adapted in use to reduce the pressure of a gas or flow rate of liquefied gas, said gas adaptor having:
(i) means for connection to a gas source;
(ii) an adaptor body having an internal bore in which is located a ceramic insert; and
(iii) a capillary tube or passage in fluid communication with the internal bore,
   wherein in use the gas or liquefied gas is caused to flow through the internal bore of the adaptor body and through the ceramic insert and subsequently through the capillary tube or passage.

It has now been discovered that the omission of a regulator does not require the use of an electronic valve or a first and second restrictor tube as described in WO2006/108244 and that use may be made of a gas adaptor described above having the adaptor body attachable to the gas container which contains the ceramic insert in the internal bore of the adapter body which is in fluid communication with the internal bore. This is a much simpler structure than the structure described in WO2006/108244.

The invention therefore is the adoption of the ceramic insert in the internal bore of the adaptor body in combination with the capillary tube or passage which is an effective substitute for the conventional regulator.

The capillary tube is preferably an elongate tube of relatively restricted inside diameter or transverse dimension which preferably is formed from copper or material that self seals if the capillary tube is damaged or cut. In another arrangement the capillary tube may be replaced by a passage drilled or machined in an elongate body. However the capillary tube is preferred.

Preferably the gas adaptor is adapted in use to interconnect a high pressure gas source to gas utilization apparatus wherein the initial high pressure of the gas is reduced to a lower operating pressure relevant to operation of the gas utilization apparatus. In this arrangement therefore the gas adaptor may include means for connection to the gas utilization apparatus.

The means for connection to the gas utilization apparatus may involve a screw threaded connection between a low pressure end fitting and the gas utilization apparatus. Alternatively a male-female, plug socket engagement may be utilized using an interference fit. Alternatively a “snap in” or “click-in” connection may be used where the low pressure end fitting has a tail or plug that automatically engages with a socket of corresponding cross sectional shape.

Preferably the capillary tube or passage is provided with a flexible or rigid protective hose which is attached to the adaptor body and the connection means to the gas utilization apparatus.

The connection means to the high pressure gas source may involve screw threaded engagement between the adaptor body and the high pressure gas source. Thus for example the adaptor body itself may be screw threadedly engaged with the high pressure gas source or have a fitting which incorporates a screw thread rotatably mounted to the adaptor body.

The connection means in other arrangements may include a plug-socket or male-female engagement between the adaptor body or connection member mounted to the adaptor body such as by way of interference fit. However a screw threaded engagement is preferred.

The adaptor body may have a unitary or one piece construction or alternatively include two or more components which may for example be a protective sleeve which protects a high pressure end of the rigid or flexible protective hose. The protection sleeve may be screw threadedly engageable with an inner bore of the adaptor body.

In another embodiment the adaptor body may include a sealing member which engages in a high pressure end of the adaptor body which seals the ceramic insert within the internal bore of the adaptor body. There may be provided a pair of resilient members such as O rings located at each end of the ceramic insert so as to vary the gas flow rate through the ceramic insert. The degree of adjustment may be regulated by the sealing member which is preferably a screw threadedly engageable in the inner bore of the adaptor body so that tightening or loosening of the sealing screw will adjust the gas flow rate through the ceramic insert.

### BRIEF DESCRIPTION OF THE FIGURES

Reference may now be made to a preferred embodiment of the present invention wherein:

FIG. 1 is a side view of the gas adaptor of the invention;

FIG. 2 is a sectional side view of the gas adaptor of the invention;

FIGS. 3-4 are views of another embodiment of the invention different to that shown in FIGS. 1-2;

FIG. 5 is a view of an alternative embodiment of the invention different to that shown in FIGS. 1-2;

FIG. 6 is a perspective view of the gas adaptor of the invention fitted to a gas bottle at a high pressure end and to a gas outlet fitting at the lower pressure end;

FIG. 7 is a perspective view of a gas burner to which the gas outlet fitting shown in

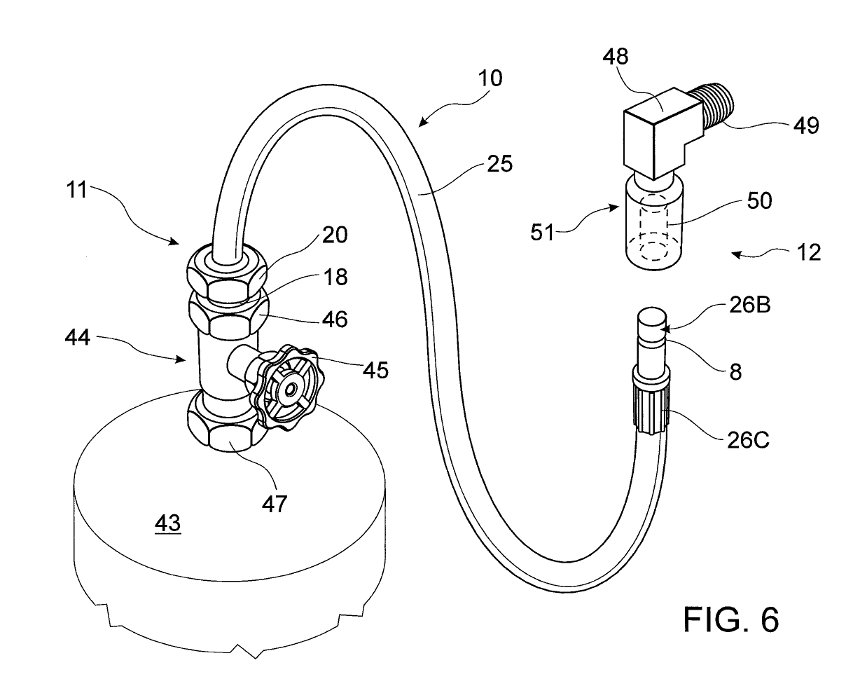

FIG. 6 is attached; and

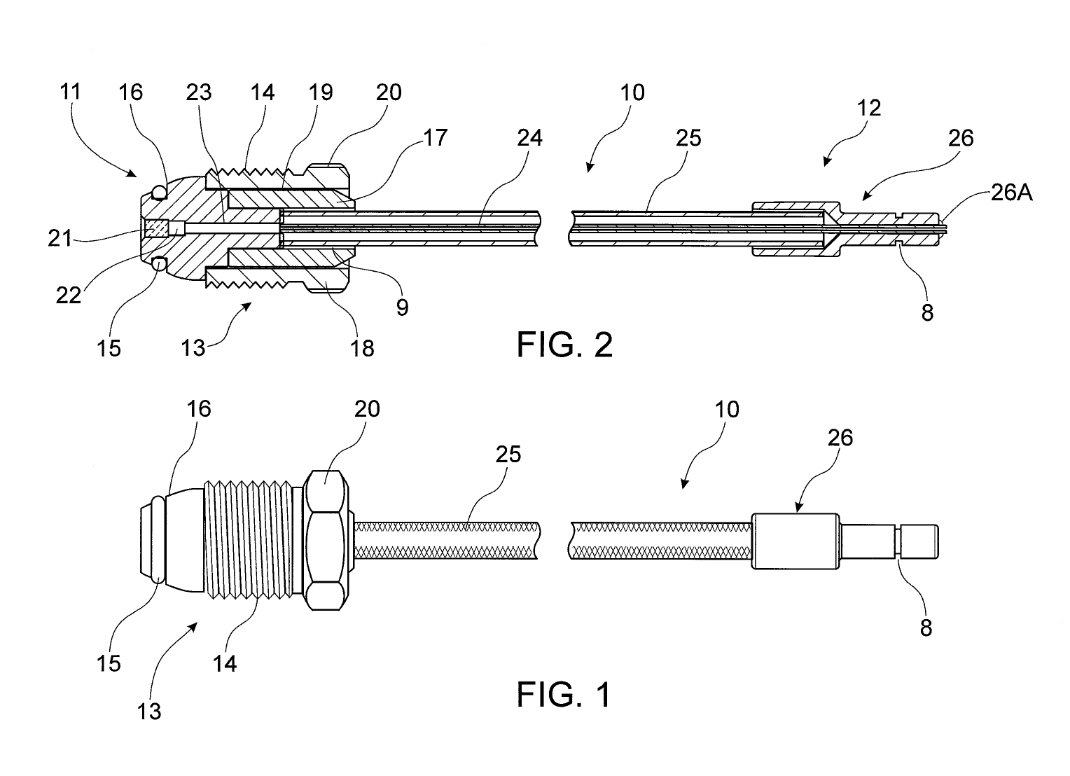

FIG. 8 is a perspective view of the gas adaptor of FIGS. 1 to 2 connected to a high pressure gas source and allowing the resulting low pressure gas to flow to atmosphere;

FIG. 9 is an exploded view of a catalytic gas converter assembly connectable to the gas adaptor of the invention;

FIG. 10 is an assembled view of the catalytic gas converter assembly shown in FIG. 9;

FIG. 11 is a perspective view of the catalytic converter assembly of FIGS. 9-10 connected to the gas adaptor of the invention; and

FIGS. 12-14 show installation of the converter assembly of FIGS. 9-10 to an insect trap.

FIG. 15 shows an exploded view of another embodiment of the gas adaptor of the invention wherein the ceramic insert is located in a disposable plastics washer.

FIG. 16 is a sectional view of the embodiment shown in FIG. 15; and

FIGS. 17-22 illustrate various aspects of another embodiment of the gas adaptor of the invention wherein a restricted zone is imparted to the capillary tube so as to better control the flow of gas through the capillary tube.

### DETAILED DESCRIPTION

In the drawings there is shown gas adaptor 10 having a high pressure end 11 and a low pressure end 12. The gas adaptor 10 at the high pressure end 11 has a body 13 having a screw thread 14 adapted to be screw threadedly attached to a suitable source of high pressure gas. This source may include for example 200×10⁵ Pa in relation to medical applications as described in U.S. Pat. No. 5,566,713 or may include or in the case of portable gas tanks used as oxygen sources in the medical field pressures inclusive of 2200 psig in the USA or 3000 psig in Europe. Such pressures may be reduced by the use of pressure regulators as described in U.S. Pat. No. 6,318,407 to 50 psig in the USA and 45-60 psig in Europe. In relation to gas bottles of carbon dioxide, liquid petroleum gas (LPG) or butane suitable high pressures may be 1200 psig for carbon dioxide, 240 psig for LPG and 60 psig for butane.

Body 13 is suitably made from metal inclusive of stainless steel, brass or aluminium with brass being preferred and has an O-ring 15 mounted in a mating groove 16 for connection to the high pressure gas source. There is also provided an inner sleeve 17 and an outer sleeve 18 rotatably supported on inner sleeve 17 and which has screw threaded portion 14. There is also provided nut component 20 which is an integral part of outer sleeve 18.

There is also provided a ceramic insert 21 which may correspond to the ceramic insert described in U.S. Pat. No. 5,018,965 which is totally incorporated herein by reference. However insert 21 is cylindrical and may be formed from aluminium oxide and provided with a slight taper (not shown) to facilitate insertion into internal bore 22 of body 13 which has a corresponding diameter to insert 21. Body 13 may also have a further inner bore 23 of smaller diameter than internal bore 22.

Ceramic insert 21 is suitably a mesoporous ceramic material having a pore size of 2-50 nm and may be made of metal oxides such as aluminium oxide, zirconia or non oxides such as carbides, borides, nitrides or silicides or composites of these materials. Particular examples of ceramic materials include barium titanate, bismuth strontium calcium copper oxide, boron carbide, boron nitride, ferrite, lead zirconate titanate, magnesium diboride, silicon carbide, silicon nitride, steatite, uranium oxide, yttrium barium copper oxide or zinc oxide.

However it will also be appreciated that ceramic insert 21 may be formed from non crystalline materials such as clays, cement or glass or crystalline materials inclusive of metal compounds discussed above.

A suitable method of manufacture of ceramic insert 21 is mainly based on sintering methods where the ceramic body is baked in a kiln where diffusion processes cause the ceramic body to shrink and the internal pores close up, resulting in a denser stronger product. Manufacture of high performance ceramics is described for example in “Organic Additives and Ceramic Processing” by D J Shanefield, Kluwer P which reference is totally incorporated herein by reference.

In the drawings there is also shown a capillary tube 24 which may have an inside diameter of 0.001-0.05 inches and more preferably an inside diameter of around 0.026 inch. The capillary tube 24 may be formed from any suitable material which is preferably self sealing in the event of damage or being melted by a flame. A suitable material is copper although aluminium or stainless steel may be utilized if required although they are less preferred than copper.

The capillary tube 24 has a protective sheath of stainless steel braided hose 25 and this may be pushed into open ended passage 9 of body 13 and retained therein by interference fit. The capillary tube 24 and its protective sheath or hose 25 may be of any desired length. The protective hose 25 may be formed from other suitable material such as rigid plastics material inclusive of Teflon, polyethylene or propylene but it is preferred that a flexible material such as stainless steel or Teflon braided hose be utilized.

The low pressure end 12 of capillary tube 24 extends through outlet fitting 26 and is welded thereto at 26A. Outlet fitting 26 is designed to be compatible with conventional corresponding apertures or sockets on apparatus utilizing the gas from the high pressure source and thus may be a “click-in” interconnection of plug and socket. In FIG. 2 outlet fitting 26 may be provided with a groove 8 which may engage with a circlip (not shown) after extending through a suitable socket. The outlet fitting 26 therefore may be connected to any suitable gas utilization apparatus requiring a gas input and this may include insect traps which may require carbon dioxide, pilot lights, catalytic converters, barbeques or gas heaters as well as SCUBA apparatus.

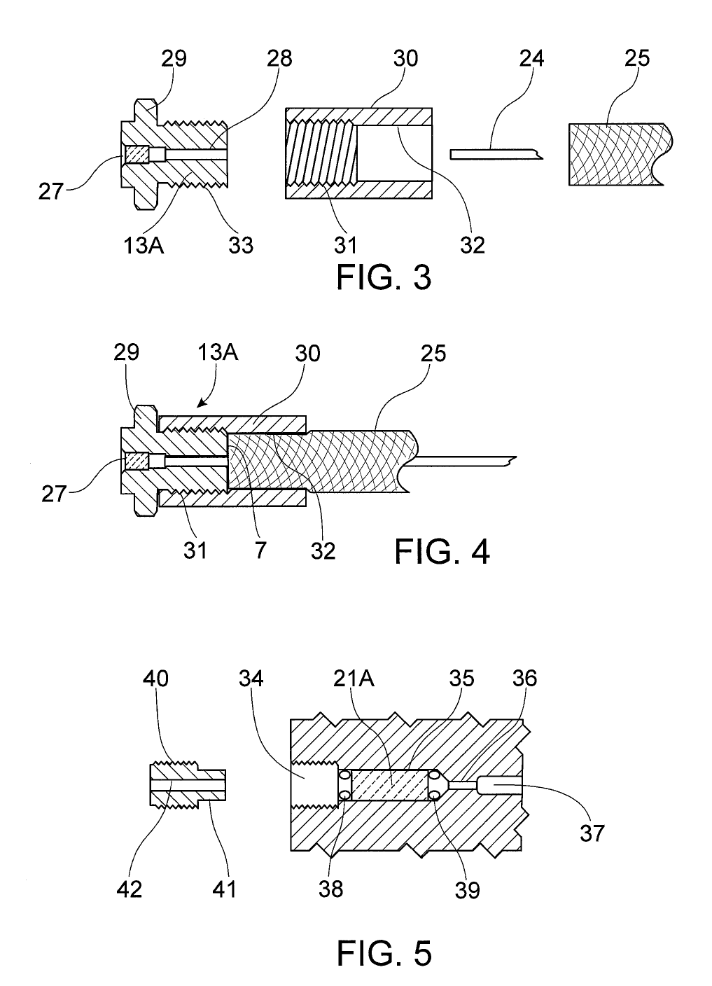

In FIGS. 3-6 there are shown alternative embodiments to those described in FIGS. 1-2. In FIG. 3 there is shown a high pressure end adaptor body 13A having an outer bore 27 of wider diameter than inner bore 28. There is also provided abutment 29. There is further provided a protective sleeve 30 which has a screw threaded internal bore 31 and an unthreaded internal bore 32. Bore 31 functions as a socket in receiving screw threaded portion 33 which functions as an insert or plug. There is also provided a capillary tube 24 and a protective sheath or hose 25 preferably made from stainless steel braided hose.

In FIG. 4 the components shown in FIG. 3 are assembled as shown wherein protective sleeve 30 is screw threadedly attached to adaptor body 13A to protect hose 25. In assembly the sleeve 30 is slid over capillary tube 24 and butted against abutment 29. The capillary tube 24 is welded to adaptor body 13A at 7.

In FIG. 5 there is shown a method of mounting a ceramic body 21A in adaptor body 13 or 13A which is provided with an outer bore 34 of wider diameter than intermediate bore 35 of lesser diameter. There is also provided an adjacent passage 36 of restricted diameter and an end passage 37 of greater diameter for retention of capillary tube 24. Ceramic insert 21A is shown inserted in intermediate bore 35 and there is also provided O-rings 38 and 39 as shown also retained in intermediate bore 35. In outer bore 34 there is provided a sealing screw 40 wherein tightening of sealing screw 40 having insert end 41 for engagement with bore 35 which reduces the inside diameter of each of O-rings 38 and 39 and thus restricts gas flow through ceramic insert 21A. Sealing screw 40 also has internal bore 42. This gives a mechanism of adjusting gas flow through ceramic insert 21A to equate with a directed flow rate, i.e. of the order of 0.5-10 grams/hr and more preferably about 2 grams/hr.

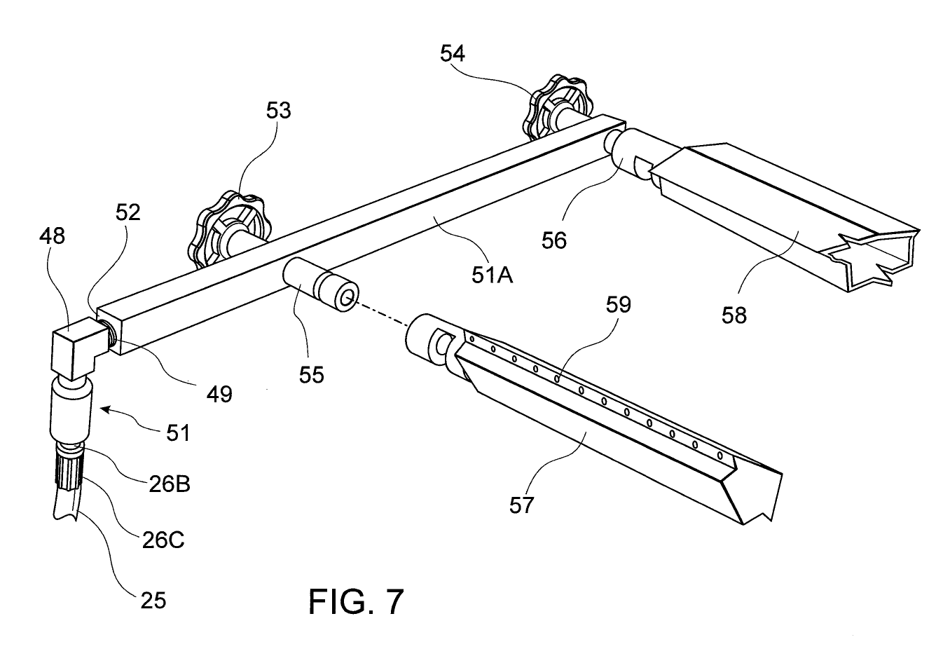

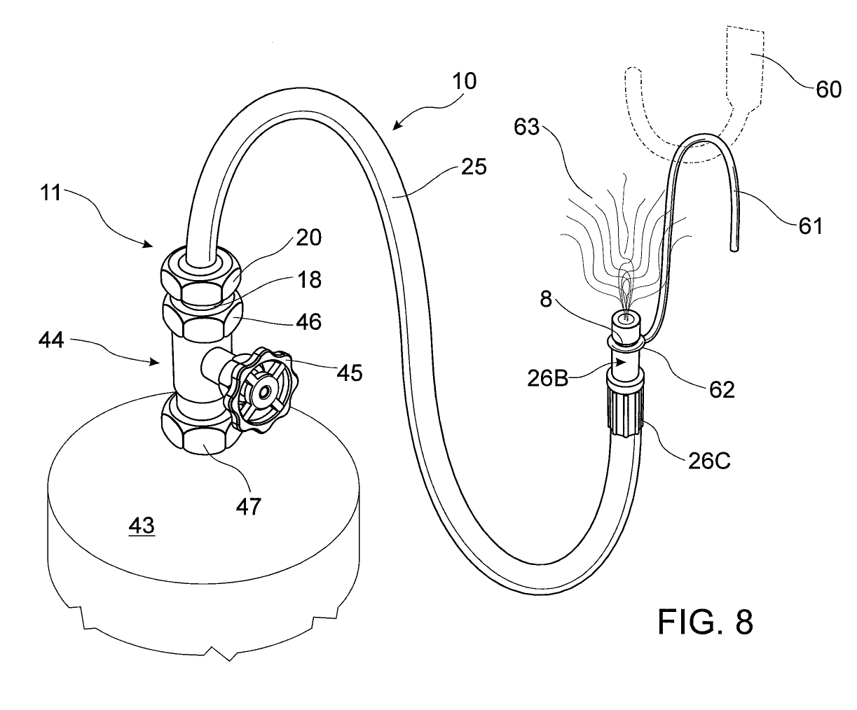

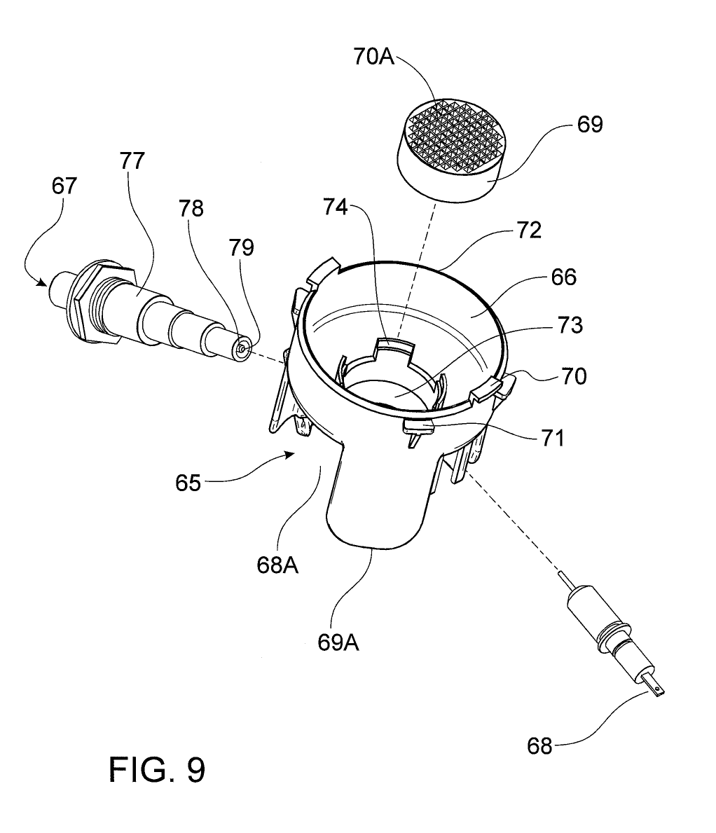

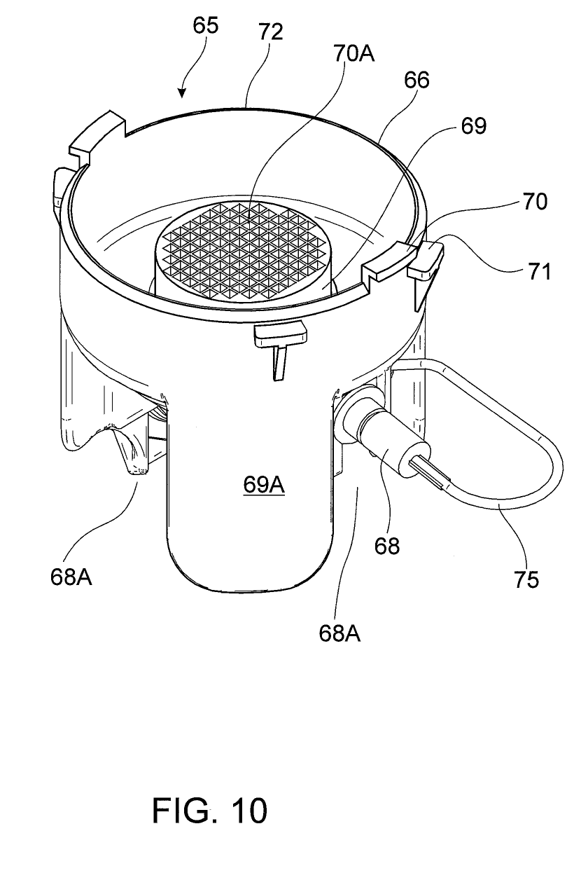

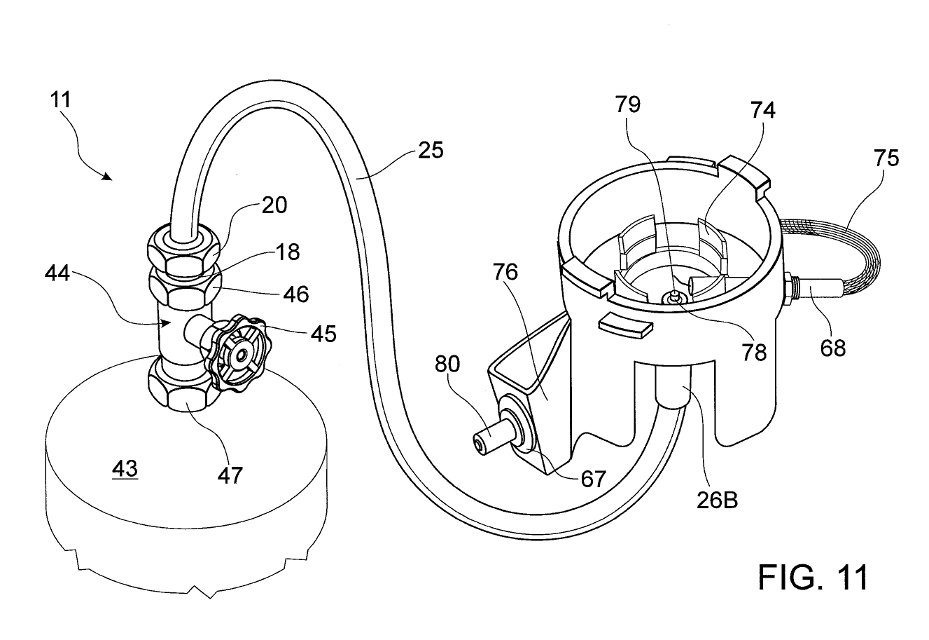

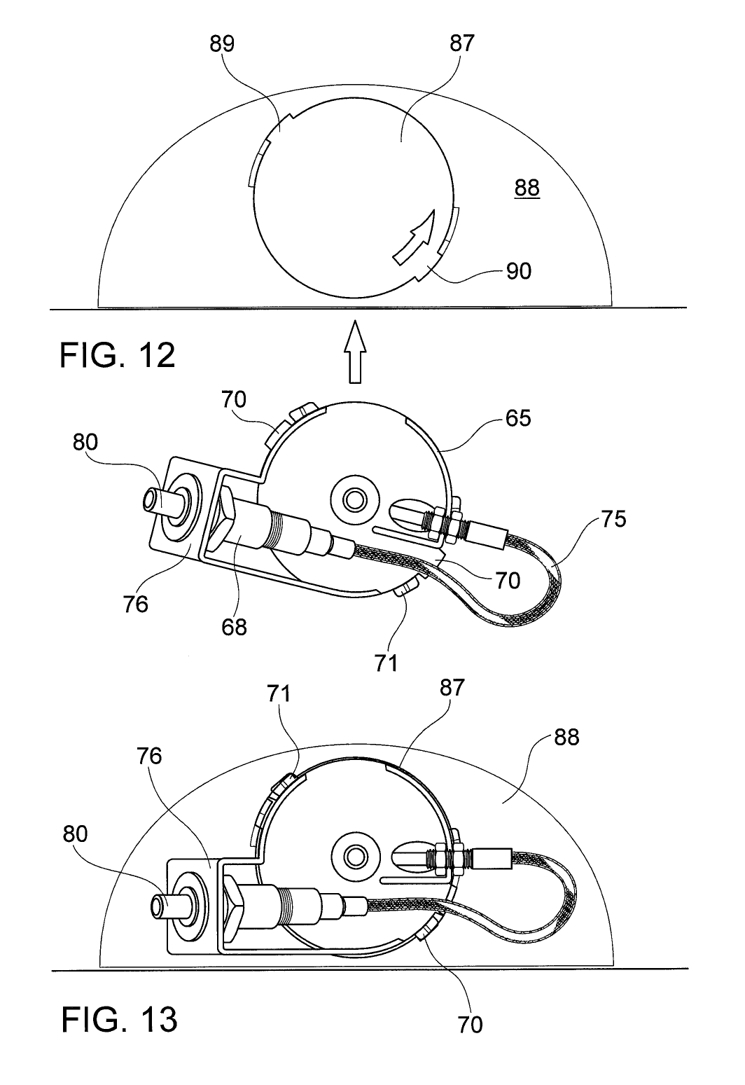

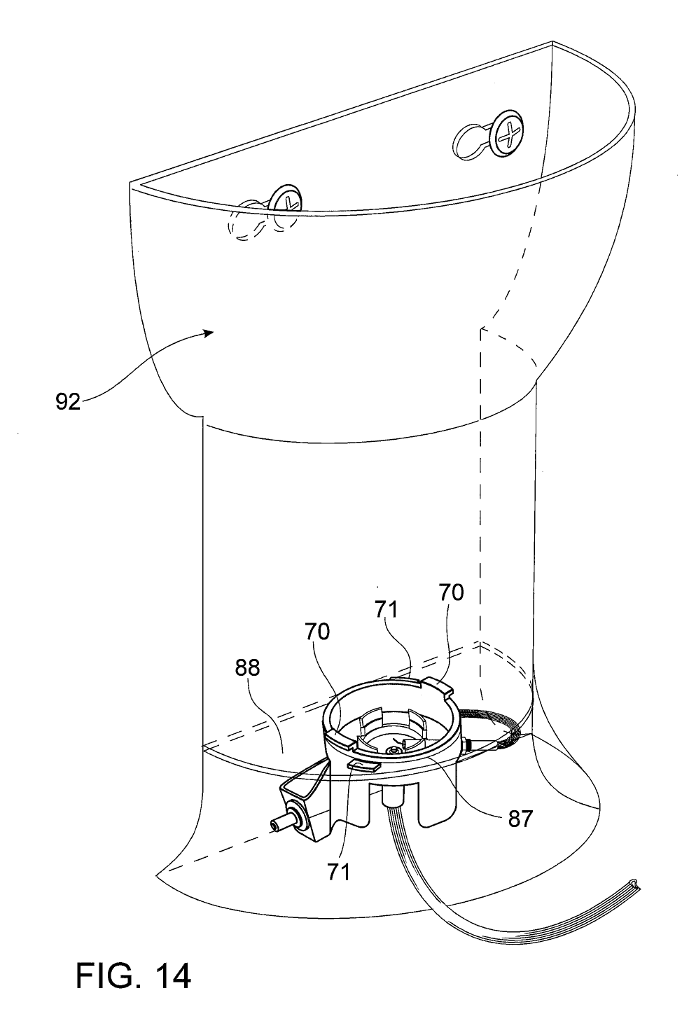

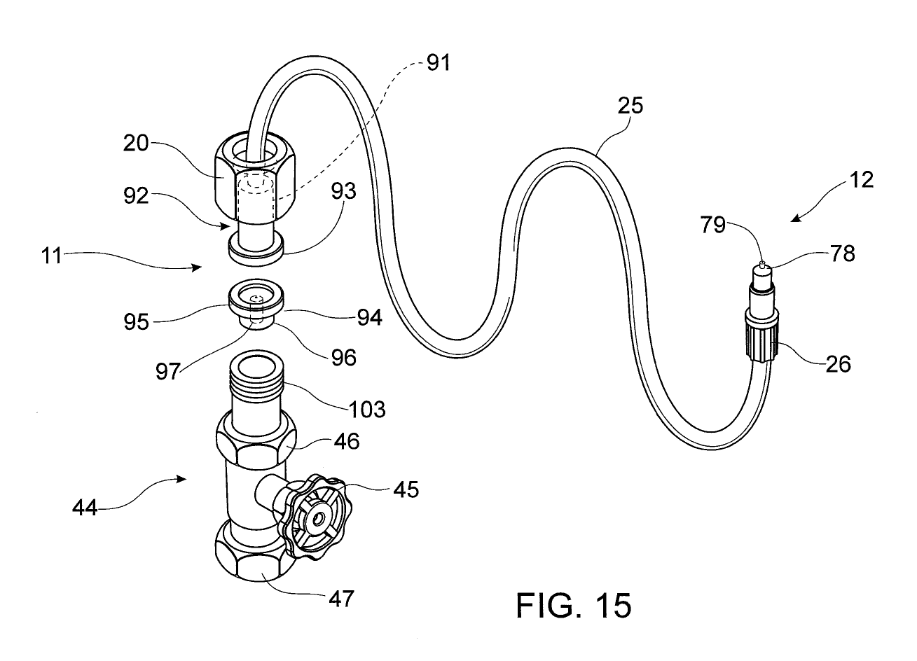

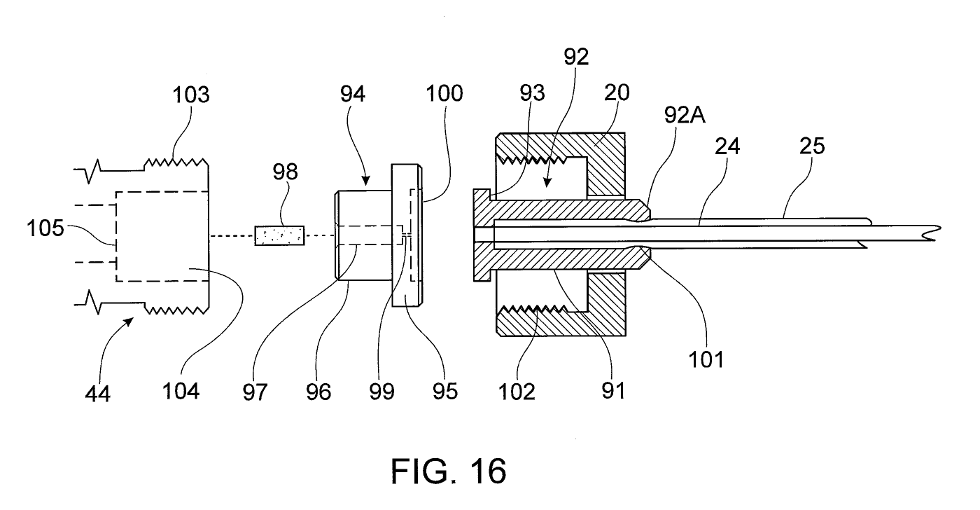

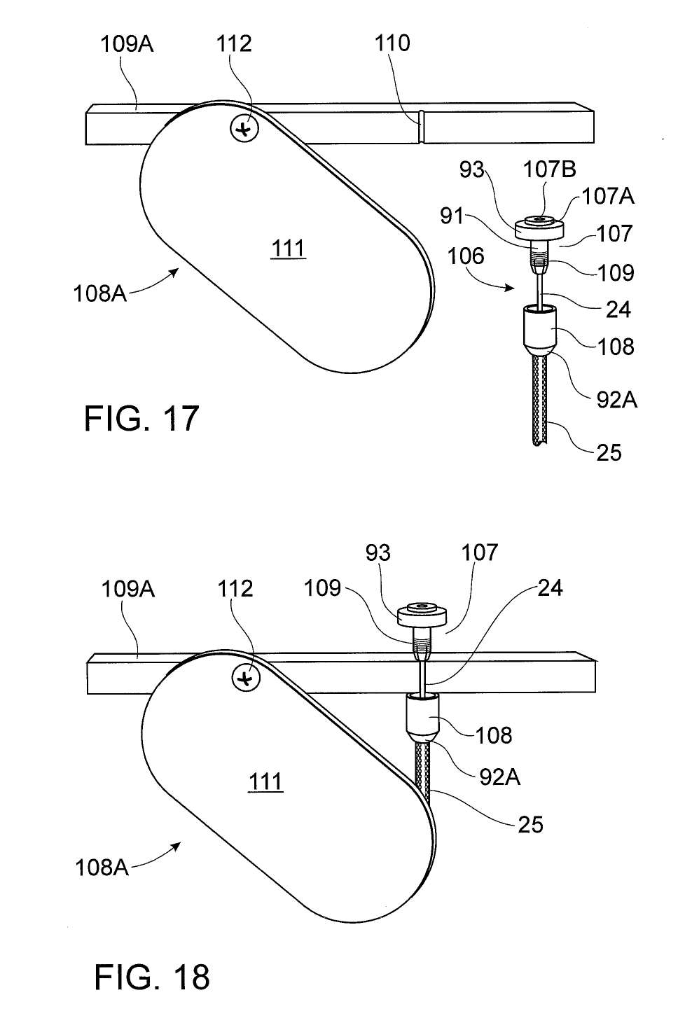

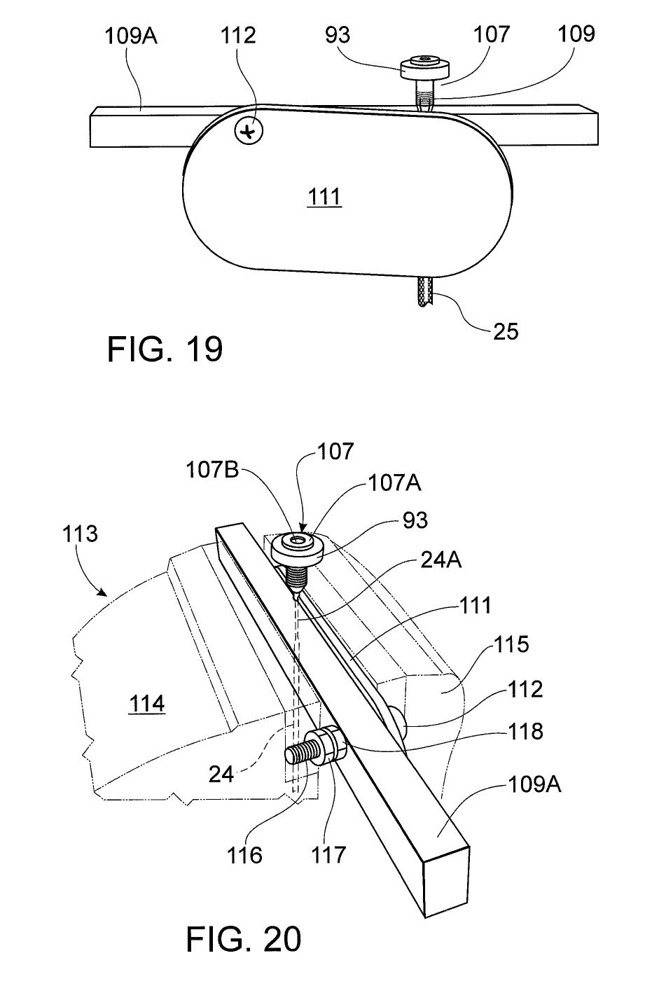

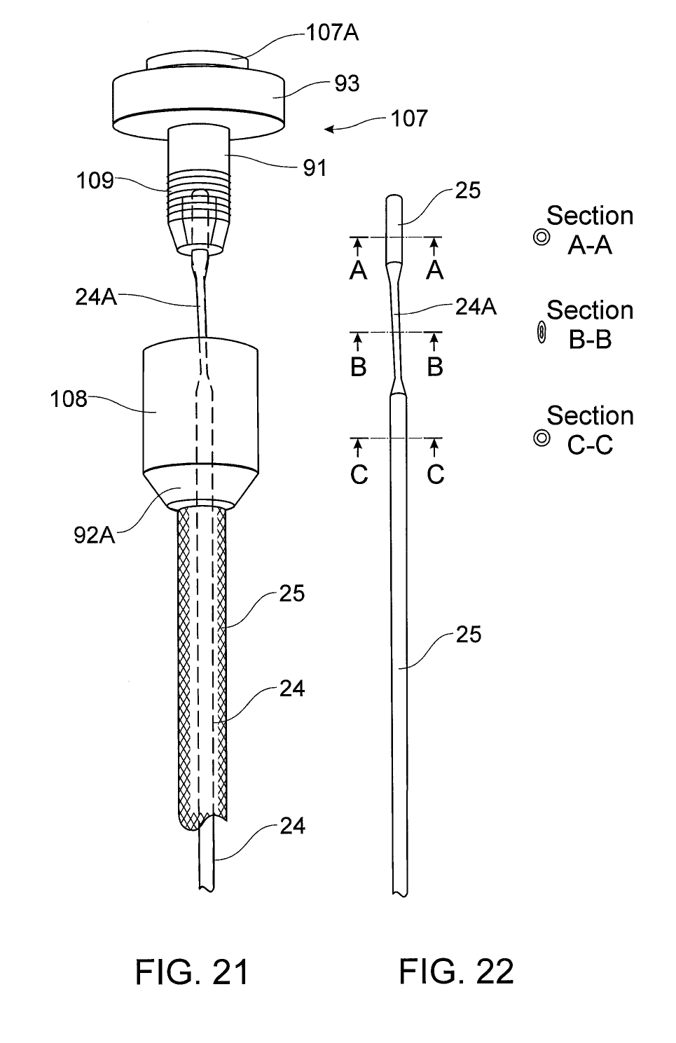

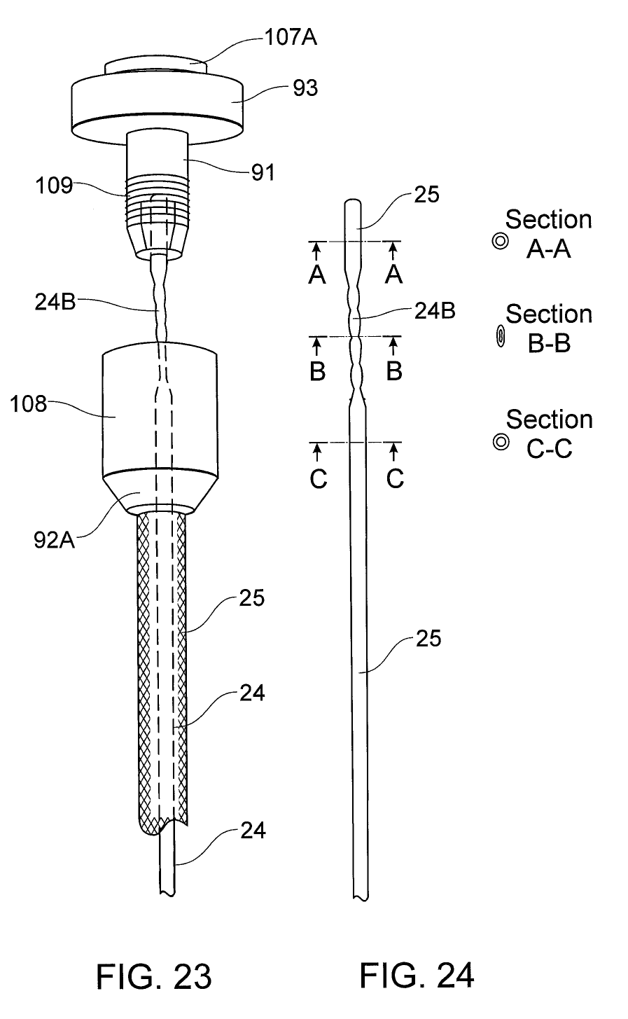

In FIG. 6 there is shown gas adaptor 10 at the high pressure end 11 fitted to a high pressure gas bottle 43 wherein sleeve 18 and integral nut component 20 are screw threadedly attached to a mating screw threaded bore (not shown) in gas outlet fitting 44 of gas bottle 43. There is also provided an adjustment handle 45 for regulating gas flow from gas bottle 43 and nuts 46 and 47 of gas outlet fitting 44. At the low pressure end 12 the outlet fitting 26 is shown engageable with a gas appliance inlet fitting 51 which has mating socket 50 of corresponding shape to outlet fitting 26B as well as elbow 48 and screw threaded plug 49 which as shown in FIG. 7 screw threadedly engages with a mating socket 52 of gas manifold 51A having adjustment knobs 53 and 54 and gas fittings 55 and 56 which engage with gas burners 57 and 58 each having flame apertures 59. There is also shown in FIG. 6 a modified outlet fitting 26B having metal ferrule 26C.

In FIG. 8 there is shown the gas adaptor 10 of the invention attached to high pressure gas bottle 43 as shown in FIG. 6. However in the FIG. 8 embodiment the gas outlet 26 is attached to a hook 60 by a mating hook 61 having a base part 62 engaged in groove 8. This allows gas 63 to issue to atmosphere. This is useful in when the gas is carbon dioxide which allows for attraction of insects such as mosquitoes which may be collected in a suitable trap (not shown).

In operation gas from gas bottle 43 is caused to flow through ceramic insert 21 or 21A which is mesoporous as described above. The ceramic insert provides a fixed pressure and flow rate for the gas although this may be adjusted as described in FIG. 5. The gas flow through capillary tube 24 is controlled by the internal diameter of capillary tube 24 which is sufficiently small to limit the gas volume in capillary tube 24 through the action of friction. The volume of gas flow through capillary tube 24 is also controlled by the length of capillary tube 24. The advantages of the gas adaptor of the invention include the following:
(i) no regulator valve is required to be attached to the outlet of the high pressure gas source;
(ii) flame cannot pass through ceramic insert 21 or 21A or capillary tube 24. This means there can be no flashback;
(iii) if the capillary tube is cut it preferably cuts off the flow of gas and this factor will also prevent flashback;
(iv) the gas adaptor of the invention provides safe micro control of gas flow and pressure.

FIGS. 9-10 show a catalytic converter assembly 65 having hollow support body 66, piezo starter head unit 67 shown in FIG. 11, spark end 68, and ceramic support 69 supporting a ceramic layer 70A. Ceramic layer 70A may comprise suitable catalysts such as Group VIII metals inclusive of platinum, palladium, silver or rhodium. Hollow support body 66 is also provided with apertures 68A located on either side of side wall projection 69A. There is also provided upper retaining lugs 70 and lower retaining lugs 71 adjacent top edge 72 of hollow support body 66. Ceramic support 69 is retained in base aperture 73 by support tabs 74 shown in FIG. 11. There is also shown conductor 75 in FIG. 10 interconnecting spark end 68 and piezo starter head unit 67.

FIG. 11 shows hollow support body 65 connected to a gas cylinder 43 by braided hose 25 which corresponds to the gas adaptor of the invention. Gas hose 25 has an outlet 26B as described in FIG. 8 and gas may issue from a hollow bore 79 of pin 78. Hollow support body 65 also has side protrusion 76 which supports piezo starter head unit 67 which also has actuator button 80. Gas hose 25 is connected to cylinder 43 as described in FIG. 8.

FIGS. 12-14 show how hollow body 65 locates in a bottom aperture 87 of a wall 88 of a mosquito trap 92. In this arrangement top lugs 70 of hollow body 65 are aligned with notches 89 and 90 of aperture 87 and hollow body 65 is rotated as shown by the arrow in FIG. 12 so that after lugs 70 pass through notches 89 and 90 and after rotation each lug 71 abuts a bottom surface of wall 88 surrounding aperture 87 and each lug 70 abuts a top surface of wall 88 surrounding aperture 87 as shown in FIG. 14. Wall 88 is shown in FIG. 14 as being part of a mosquito trap 92.

In operation of the catalytic converter assembly 43 propane gas passes through gas hose 25 from gas cylinder 43 after opening of gas flow by control handle 45. The propane gas is then caused to flow through hollow bore 79 of pin 78 and is ignited by a spark from spark end 68 to be oxidised to carbon dioxide. The spark is caused by movement of actuator button 80 and the propane is catalytically converted to carbon dioxide by catalyst layer 70. The resulting carbon dioxide is a well known attractant for mosquitoes. The hollow support body 65 incorporates a conductive carbon content to avoid use of an earth wire.

In another aspect of the invention there is also provided a method of operating a gas adaptor connected to a source of gas or liquefied gas to reduce the pressure of the gas or the flow rate of the liquefied gas, said method including the steps of:
(i) causing the gas or liquefied gas to flow through a ceramic insert to reduce the pressure of the gas as well as flow rate of the liquefied gas; and.
(ii) causing the gas or liquefied gas after flow through the ceramic insert to flow through a capillary passage of restricted diameter or transverse diameter.

After step (ii) the gas adaptor may be connected to gas utilization apparatus as described above which is in flow communication with the capillary passage or alternatively the gas may flow to atmosphere as shown in FIG. 8.

It will be appreciated from the foregoing that the gas adaptor of the invention is adapted to reduce an initial pressure of a gas to produce a gas at lower pressure. However it will be evident that the gas adaptor of the invention may also reduce a flow rate of a gas and this is especially applicable to a liquefied gas which flows through the ceramic insert and subsequently through the capillary tube or passage.

Reference may now be made to another embodiment of the invention shown in FIGS. 15-16 which shows protective hose 25 having outlet fitting 26B as described in relation to the FIGS. 10-11 embodiment at low pressure end 12. Protective hose 25 at the high pressure end 11 is provided with a metal tubular end component 92 suitably made from brass which has a head part 93, shank 91 and tapered part 92A. There is also provided a washer or sleeve component 94 suitably made from plastics material such as PVC, polypropylene or nylon which has a head portion 95 and a body 96 which is also provided with an inner bore or passage 97 for receiving a ceramic insert 98. The inner bore 97 is provided with a further passage 99 best shown in FIG. 16 of greatly reduced diameter compared with inner passage 97. The plastics washer 94 is also provided with an end recess 100 for accommodating head portion 93 of end component 92. It will also be noted that capillary tube 24 of hose 25 is located closely adjacent to passage 99 in use. Protective hose 25 is bonded to an internal surface of end component 92 at 101.

When each of the components shown in exploded relationship in FIG. 15 are assembled internal screw thread 102 of nut 20 engages with external thread 103 of gas fitting 44. It will be noted that body 96 of plastics washer 94 locates within recess 104 of gas outlet fitting 44 adjacent inner bore 105 shown in FIG. 15.

The advantage of having plastics washer 94 in abutting relationship and separate from tubular end component 92 (i.e. it is not secured or connected to component 92 such as by screw threaded engagement) is that when thread 102 engages thread 103 and thus, brings washer 94 and component 92 into contact or abutting relationship there is provided a secure seal in relation to the gas so that all the gas flows through inner bore 97 and into capillary passage 24.

The advantages of locating the ceramic insert 98 inside plastics washer 94 means that fitting or assembly of the ceramic insert 98 to hose 25 is very much simplified compared to the arrangements shown in FIGS. 1-5 where it was necessary to bond the ceramic insert 21 to inner bore 22. This was difficult to achieve in some cases but more importantly it was extremely difficult to disconnect the ceramic insert 21 from internal passage 22. One of the most important functions of ceramic insert 21 was to act as a filter and filter out impurities from the gas coming from gas bottle 43. Common impurities were oil droplets which were obtained from an oil coating within the gas bottle 43 or sugar particles or syrup particles having regard to a prior use of the gas bottle 43. Such impurities were often entrained with the gas as a result of careless or incomplete cleaning of the gas bottle 43.

As a result of the impurities reaching ceramic insert 21 or capillary tube 24, there was often a complete blockage and thus, gas flow through capillary tube 24 was prevented. If such was the case it was then necessary to throw away the entire gas adaptor 10 and order a new one. This was an expensive procedure. This problem was overcome by the provision of a separate component such as plastics washer or sleeve 94 wherein ceramic insert 98 could be pushed into accommodating internal bore 97 by press fit or interference fit. This made plastics sleeve or washer 94 a throwaway or disposable item and capable of being readily replaced by a fresh or substitute sleeve 94 having insert 98 already fitting thereto in bore 97.

Further embodiments of the invention are shown in FIGS. 17-24 wherein capillary tube 24 was subjected to a crimping or clamping operation or twisting so as to be provided with a restricted zone for reducing gas flow through capillary tube 24. One method of providing a restricted zone is shown in FIGS. 17-22 wherein capillary tube 24 is shown attached to end component 106 similar to end component 92 but being formed by separate parts 107 and 108 as shown wherein part 107 has external thread 109 for fitting to an internal thread (not shown) of part 108 to clamp hose 25 to end component 106 adjacent neck 92A. Part 107 in this embodiment also has raised boss 107A and internal bore 107B for engagement with internal bore 99.

In FIG. 17 there is also provided a clamping apparatus 108A having an elongate bar or rod 109A having a notch 110. There is also provided a clamping plate 111 pivotally attached to rod 109 at 112.

In FIG. 18 capillary tube 24 is located within notch 110 and in FIG. 19 is contacted by clamping plate 111 which as shown in FIG. 20, produces a restricted zone 24A when placed in a vice 113. Thus capillary tube 24 is squeezed or clamped by plate 111 within notch 110 so as to produce restricted zone 24A. Vice 113 includes moveable jaw 114 and fixed jaw 115 as is well known with conventional bench vices. There is also shown pivot bolt 116 and nuts 117 and 118 so as to pivotally attach clamping plate 111 to rod 109 at 112.

The production of restricted zone 24A is shown in FIGS. 21-22 wherein Sections A-A, B-B and C-C in FIG. 22 show the length of the restricted part 24A relative to the non-restricted capillary tube 25.

In a further embodiment as shown in FIGS. 23-24 similar to FIGS. 21-22 restricted zone 24A of capillary tube may instead of being clamped may be twisted to form a twisted part 24B which is similar in effect to restricted or clamped zone 24A.

The production of restricted zone 24A of capillary tube 24 means that the diameter of restricted zone 24A may be varied to suit production of various gas flows. However, a suitable range may be from 0.005 to 0.2 mm compared to an internal diameter of the unrestricted part 25 which may vary from 0.025 to 1.25 mm in internal diameter. The restricted zone 24A may also produce a flow rate of gas through the restricted zone 24A at a flow rate of 5-30 gm of gas per day and more suitably 18 gm of gas per day.

It will also be appreciated that the production of the restricted zone 24A will greatly increase frictional contact of the gas with an internal surface of restricted zone 24A and which greatly reduces the flow of the gas. Therefore, gas flow may be produced in pulses whereby separate pulses are produced by a build up in gas pressure to pass through the zone 24A. Another factor on gas flow rate will also be the length of zone 24A which may vary from 10-125 mm in length. Obviously the greater the length of restricted zone 24A the greater reduction in gas flow that may be achieved.

It will also be appreciated that multiple restricted zones 24A may be produced but it is preferred that there is only a single restricted zone.

The major advantage that will be provided by restricted zone 24A is that a bottle of gas will last substantially longer with the substantial reduction in gas flow as discussed above. Thus, gas bottle pressure may be reduced from approximately 60-3000 psi in gas bottle 43 as described above to less than 5 psi when the gas passes through the zone 24A.

What is claimed is:

1. A gas adaptor adapted in use to reduce the pressure of a gas or flow rate of a liquefied gas, said gas adaptor having:
(i) means for connection to a gas source;
(ii) an adaptor body having an internal bore in which is located a ceramic insert; and
(iii) a capillary tube or passage in fluid communication with the internal bore wherein in use the gas or liquefied gas is caused to flow through the internal bore of the adaptor body and through the ceramic insert and subsequently through the capillary tube or passage.

2. A gas adaptor as claimed in claim 1 where in capillary tube or passage has an inside diameter of 0.001-0.05 inches.

3. A gas adaptor as claimed in claim 2 wherein the capillary tube has an inside diameter of 0.026 inch.

4. A gas adaptor as claimed in any claim 1 wherein the capillary tube is formed from material that is self sealing in the event of damage.

5. A gas adaptor as claimed in claim 4 wherein the capillary tube is formed from copper.

6. A gas adaptor as claimed in claim 1 wherein the capillary tube is welded to the adaptor body adjacent the ceramic insert.

7. A gas adaptor as claimed in claim 1 wherein the capillary tube is provided with a protective sheath or sleeve.

8. A gas adaptor as claimed in claim 7 wherein the protective sheath or sleeve is formed from flexible material.

9. A gas adaptor as claimed in claim 8 wherein the flexible material is braided material formed from stainless steel or other rigid material.

10. A gas adaptor as claimed in claim 7 wherein the protective sleeve or sheath is attached to the adaptor body by an outer sleeve screw threadedly attached to the adaptor body.

11. A gas adaptor as claimed in claim 1 wherein the adaptor body has a sealing member which engages in a high pressure end of the adaptor body and thereby seals the ceramic insert in an internal bore of the adaptor body.

12. A gas adaptor as claimed in claim 1 wherein the ceramic insert has at each end thereof an O-ring or sealing ring having an inner aperture which has a diameter which is variable depending upon the location of the sealing member to provide an adjustable gas flow through the adaptor body.

13. A gas adaptor as claimed in claim 11 wherein the sealing member is screw threadedly attached to an inner bore of the adaptor body.

14. A gas adaptor as claimed in claim 1 wherein the gas adaptor further includes means for connection to gas utilization apparatus, wherein in use the reduced pressure of the gas is relevant to operation of the gas utilization apparatus.

15. A gas adaptor as claimed in claim 1 wherein an end of the capillary tube protrudes beyond an adjacent end of an outlet fitting and is welded thereto.

16. A gas adaptor adapted to reduce a flow rate of a gas, said gas adaptor having:
(i) means for connection to a gas source;
(ii) an adaptor body having an internal bore in which is located a ceramic insert; and
(iii) a capillary tube or passage in fluid communication with the internal bore wherein in use the gas is caused to flow through the internal bore of the adaptor body and through the ceramic insert and subsequently through the capillary tube or passage.

17. An adaptor body adapted to reduce the flow rate of a liquefied gas, said gas body having:
(i) means for connection to a gas source; and
(ii) an internal bore in which is located a ceramic insert,
said adaptor body in use being in flow communication with a capillary tube or passage wherein the gas is caused to flow through the internal bore of the adaptor body and through the ceramic insert and subsequently through the capillary tube or passage.

18. An adaptor body as claimed in claim 17, wherein the adaptor body is separate from the capillary tube or passage and engages with a sleeve component which incorporates the capillary tube or passage in abutting relationship.

19. An adaptor body as claimed in claim 18, wherein the adaptor body is formed of plastics material and is a disposable or throwaway item.

20. An adaptor body as claimed in claim 18, wherein both the adaptor body and the sleeve component are brought into abutting relationship with each other by provision of a nut which screw threadedly engages with a mating screw thread of a gas outlet fitting associated with the gas source.

21. A gas adaptor assembly having:
(a) an adaptor body adapted to reduce the flow rate of a liquefied gas, said adaptor body having:
(ii) means for connection to a gas source;
(iii) an internal bore in which is located a ceramic insert; and
(b) a sleeve component incorporating a capillary tube or passage having contained therein an internal bore which engages with the adaptor body in abutting relationship with the capillary tube or passage being in flow communication with the internal bore.

22. A gas adaptor assembly as claimed in claim 21, wherein there is further provided a protective sheath, sleeve or hose for the capillary tube or passage which is connected to the sleeve component.

23. A gas adaptor assembly as claimed in claim 21, wherein the adaptor body is formed from plastics material and is a disposable or throwaway item.

24. A gas adaptor assembly adapted to reduce a flow rate of a gas, said gas adaptor having:
(i) means for connection to a gas source;
(ii) an adaptor body having an internal bore in which is located a ceramic insert; and
(iii) a capillary tube or passage in fluid communication with the internal bore having at least one restricted zone wherein in use gas is caused to flow through the ceramic insert which functions as a filter to filter out impurities from the gas and said at least one restricted zone functions to reduce the flow rate of the gas.

25. A gas adaptor assembly adapted to reduce a flow rate of a gas, said gas adaptor assembly having:
(i) means for connection to a gas source;
(ii) a capillary tube or passage having at least one restricted zone wherein in use gas is caused to flow through said at least one restricted zone to reduce the flow rate of the gas.

26. A method for reducing a flow rate of a gas, said method including steps of:
(i) passing the gas through a ceramic insert to filter out impurities from the gas; and
(ii) subsequently passing the gas through a capillary tube or passage having at least one restricted zone wherein said at least one restricted zone causes said reduction in the flow rate of the gas.

27. A method of reducing a flow rate of a gas which includes the step of passing the gas through a capillary tube or passage which has at least one restricted zone which causes said reduction in the flow rate of the gas.
